(19) United States
(12) Patent Application Publication
(10) Pub. No.: US 2016/0318744 A1
(43) Pub. Date: Nov. 3, 2016

(54) BOTTLE OPENER RISER

(71) Applicant: Spencer Koroly, Spring Valley, CA (US)

(72) Inventor: Spencer Koroly, Spring Valley, CA (US)

(21) Appl. No.: 15/059,180

(22) Filed: Mar. 2, 2016

Related U.S. Application Data
(60) Provisional application No. 62/127,277, filed on Mar. 2, 2015.

(51) Int. Cl. B67B 7/16; A63C 17/26; A63C 17/00

(52) U.S. Cl. CPC B67B 7/16; A63C 17/0006; A63C 17/26

(57) ABSTRACT

This document describes a bottle opener in the form of a bottle opener riser for a skateboard. The bottle opener riser includes a riser pad portion that is sized to fit between a skateboard truck base and a bottom surface of a skateboard deck, the riser pad portion having one or more holes to receive a bolt that mounts the skateboard truck base to the skateboard deck. The bottle opener riser further includes a bottle opener portion that extends from the riser pad portion, the bottle opener portion including a fulcrum that is adapted to pry a crown of a bottle cap from an opening of a bottle.

### CROSS-REFERENCE TO RELATED APPLICATION

This application claims the benefit of U.S. patent application Ser. No. 62/127,277, filed on Mar. 2, 2015, and entitled “BOTTLE OPENER RISER,” which is incorporated by reference herein in its entirety.

### BACKGROUND

This document relates to skateboards, and more particularly to a riser for a skateboard truck riser pad, where the riser includes a bottle opener.

Skateboarding is a rigorous activity, which is usually, although not always, performed during dry days. A skateboard rider, e.g., a skateboarder, can frequently become dehydrated and/or thirsty. One problem that exists is that a container to address the dehydration and/or thirst that is accessible by the skateboarder might be a bottle with a bottle cap. Another, more serious, problem with this situation is accessibility by the skateboarder to a suitable bottle opener.

Skateboarders, while preferring to be fully or at least partially clothed, typically skateboard with a minimal number of accessories. Some accessories, such as bottle openers or the like, can inflict an injury upon the skateboarder or another person, especially if the skateboarder falls or “wipes out.” These injuries can include, inter alia, a cut, a bruise, a puncture, a slash, or putting someone's eye out.

### SUMMARY

This document presents a bottle opener for a skateboard, to address the problems described above and more. In particular, the bottle opener is provided in the form of a “riser” or extension member that is placed between a truck base and the bottom surface of a skateboard deck.

In some implementations, a riser bottle opener includes a main body that corresponds to a size and shape of a riser pad, and an extended body that includes a bottle opener portion.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings:

FIG. 1 shows a bottle opener riser;

FIG. 2 shows a bottle opener riser;

FIG. 3 shows a bottle opener riser with a bend between the riser pad portion and the bottle opener portion;

FIG. 4 shows an implementation of a bottle opener riser; and

FIG. 5 shows an implementation of a bottle opener riser.

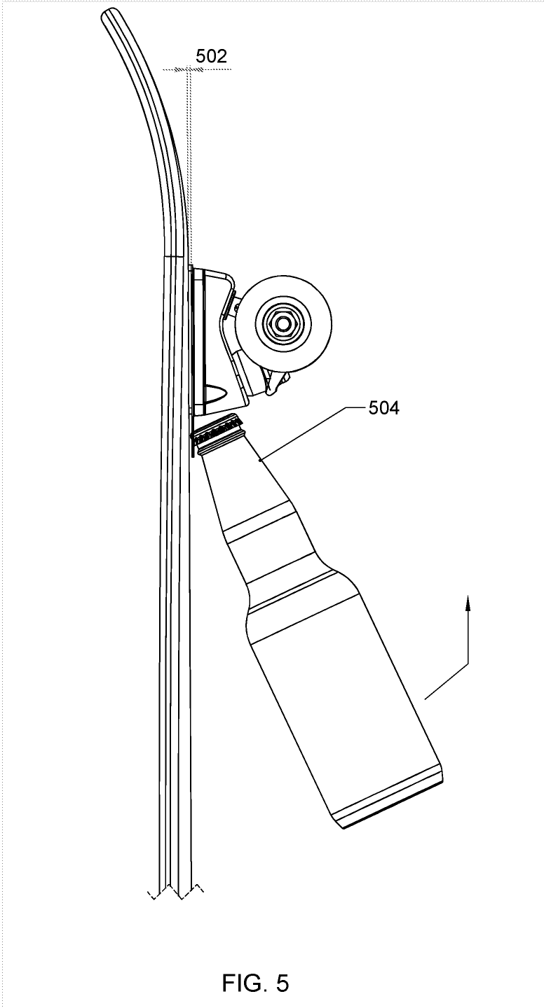

### DETAILED DESCRIPTION

This document describes a skateboard-based bottle opener riser. The bottle opener riser can be made of any rigid or semi-rigid material, such as metal, plastic, nylon, carbon fiber, or any combination thereof. The bottle opener riser can further include engravings, etchings, or apertures representing a brand name or logo or the like.

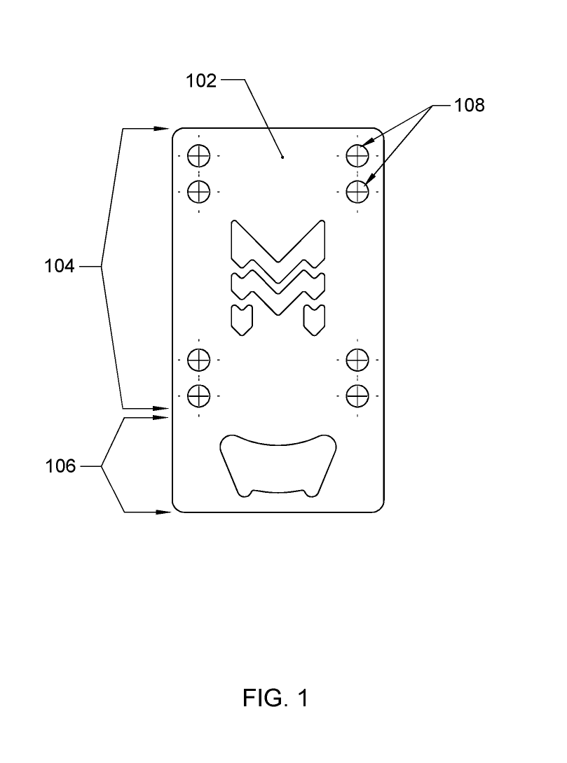

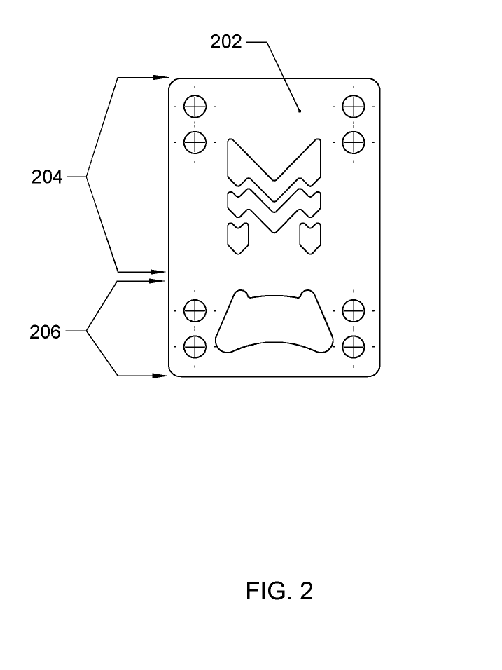

The bottle opener riser, as shown in FIG. 1 and FIG. 2, combines forms of a riser pad portion and a bottle opener portion. The form of the bottle opener riser includes a riser pad shape 104, 204 and an extended portion having a class 1 or class 2 fulcrum-style bottle opener 106, 206, such as used to pry a bottle cap from an opening to a bottle. The bottle opener portion can include a bottle opener having an aperture for receiving a part of a bottle cap, and a tab or fulcrum to lever against an oppositely-directed lever extension within the aperture, as can be seen in the figures. In other implementations, the bottle opener riser can include only an extension that couples with an underside of a bottle cap and cooperates with the bottom surface of the board to leverage the bottle cap from the bottle opening.

The bottle opener riser is installed between a skateboard deck and a skateboard truck. The bottle opener portion may be included within an elongated portion at one or more ends of the riser pad portion 108. The bottle opener riser, as sized as a riser pad, may be sized to fit into user's pocket, wallet, etc., while not serving as a riser pad or portion thereof. In some implementations, the bottle opener riser may include a bend between the riser pad portion and the bottle opener portion, to deflect the elongated portion containing the bottle opener away from skateboard deck 302. The bend provides adequate clearance between skateboard deck and the bottle opener for proper operation of the bottle opener when the bottle opener riser is installed flush to the skateboard deck 304. In other implementations, one or more riser pads can be placed above or below the bottle opener riser relative to the skateboard deck.

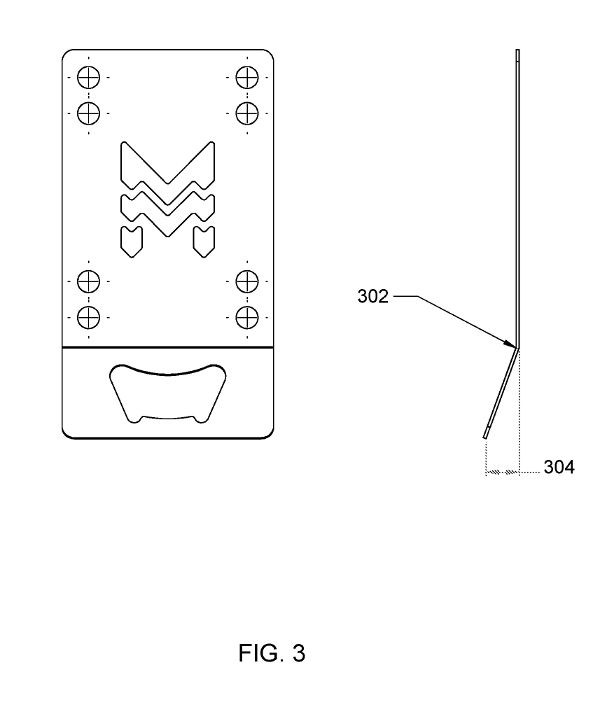

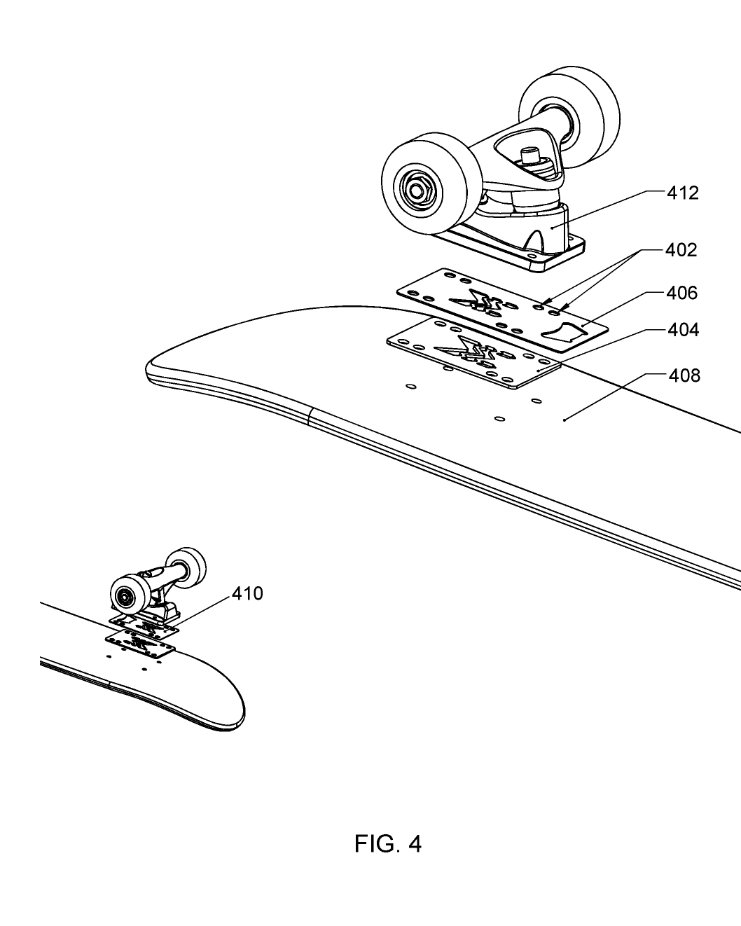

In some implementations, the riser pad portion of the bottle opener riser includes a number of holes, each to accept a standard bolt configuration that attach or couple a skateboard truck to or with, respectively, a skateboard deck. For example, in one preferred implementation, the riser pad portion of the bottle opener riser includes eight holes to accept standard bolt configurations for attaching the skateboard truck to the skateboard deck, as shown in FIG. 1, FIG. 2, FIG. 3, and FIG. 4. In other implementations, the riser pad portion can include four holes, two holes, or even one hole. In some implementations, particularly where one hole is provided in the riser pad portion of the bottle opener riser, the bottle opener portion can be swung out from a retracted position (retracted toward the truck and/or other riser pads) to a deployed position (extended out to provide the class 1 or class 1 lever for the bottle opening functionality).

In some implementations, the bottle opener risers are flat, and are installed in combination with one or more additional riser pads 404. The additional riser pads should be no less than 1/16″ (0.625″) and installed between the bottle opener riser 406 and the skateboard deck 408 in order to provide adequate clearance between the skateboard deck and the bottle opener portion of the bottle opener riser for proper operation of the bottle opener. Additional riser pads may be required if a desired thickness of the riser pad(s) is greater than a thickness of the bottle opener riser pad.

Additional riser pads may or may not be required for proper operation of the bottle opener if the skateboard deck is designed in such a manner as to provide adequate clearance between the skateboard deck and the bottle opener. For instance, the skateboard deck can be formed with a channel or indentation for providing the adequate clearance between the skateboard deck and the bottle opener. The channel or indentation can include a coating or surface that is hardened, such as metal, nylon, carbon fiber, or the like.

If a bottle opener riser is used on one skateboard truck, a matched-thickness riser pad should be installed between the other skateboard truck and the skateboard deck to ensure identical riser pad thickness on both the front and back skateboard trucks 410. In some preferred implementations, the bottle opener riser is installed on the front skateboard truck, with the elongated portion containing the bottle opener directed toward the rear of the skateboard deck 412.

The bottle opener riser functions as a riser pad to provide distance between the skateboard deck and the skateboard trucks to assist in preventing a phenomenon known as wheel bite 502. Additionally, the bottle opener riser functions as a bottle opener when the cut out shape in the elongated portion is used as a leverage point to unseat a bottle cap 504.

In operation, a skateboard positions the skateboard deck such that it is stood on end so the bottle opener riser is accessible. The crown of a bottle is placed on or in a leverage point. The crown of the bottle is forced against the leverage point as the bottle cap is forced against the fulcrum, unseating the bottle cap. Accordingly, by opening the bottle containing a hydrating or satiating liquid, the skateboarder will be able to satisfy both his or her thirst, as well as thirst for adventure.

Although a few embodiments have been described in detail above, other modifications are possible. Other embodiments may be within the scope of the following claims.

1. A bottle opener riser comprising:
a riser pad portion that is sized to fit between a skateboard truck base and a bottom surface of a skateboard deck, the riser pad portion having one or more holes to receive a bolt that mounts the skateboard truck base to the skateboard deck; and
a bottle opener portion that extends from the riser pad portion, the bottle opener portion including a fulcrum that is adapted to pry a crown of a bottle cap from an opening of a bottle.

2. The bottle opener riser in accordance with claim 1, further comprising a bend between the riser pad portion and the bottle opener portion, the bend configured to angle the bottle opener portion away from the bottom surface of the skateboard deck.

3. The bottle opener riser in accordance with claim 1, wherein the riser pad portion and bottle opener portion are contiguous.

4. The bottle opener riser in accordance with claim 1, wherein the riser pad portion and bottle opener portion are rigid.

5. The bottle opener riser in accordance with claim 1, wherein the bottle opener riser is formed of metal.
